(19) United States
(12) Patent Application Publication
(10) Pub. No.: US 2002/0102013 A1
(43) Pub. Date: Aug. 1, 2002

(54) Method for comparing signal arrays in digital images

(76) Inventor: Zeev Smilansky, Meishar (IL)

Correspondence Address: BIRCH STEWART KOLASCH & BIRCH, PO BOX 747, FALLS CHURCH, VA, 22040-0747, US

(21) Appl. No.: 10/056,483

(22) Filed: Jan. 28, 2002

(30) Foreign Application Priority Data
Jan. 29, 2001 (IL) 141151

(51) Int. Cl. G06K 9/00

(52) U.S. Cl. 382/129

(57) ABSTRACT

A method and system for comparing first and second signal arrays is provided. To each of a plurality of pixels xᵢ in the first array, a pixel T(xᵢ) in the second array is associated.

A linear regression analysis is then applied to the ordered pairs of numbers (xᵢ, T(xᵢ)) so as to produce a slope.

### FIELD OF THE INVENTION

This U.S. patent application claims priority from Israel Patent Application No. 141151 of Jan. 29, 2001. The invention relates to methods of comparing the intensity of two signal arrays in digital images, for example digital images of a spot in a one- or two-dimensional electrophoresis pattern or a DNA chip.

### BACKGROUND OF THE INVENTION

A digital image may be considered to be an array of signals, where each pixel in the image produces a visible signal of a particular intensity. It is often of interest to compare two such signal arrays. For example, to protein mixtures can be separated by one of various separation techniques to produce two one- or two-dimensional separation patterns. A digital image of a spot in each pattern, corresponding to the same protein could be compared in order to compare the is amount of the protein present in each mixture. As another example, a DNA chip having attached to it various oligonucleotide targets is incubated in the presence of probe oligonucleotides from two sources. The two probe species are differently labeled, so that each probe species produces a visible signal that is distinguishable from that of the other species, For example, one probe species may be labeled with a fluorescent dye that produces a red signal while the other probe species is labeled with a fluorescent dye that produces a green signal. A digital image of the red signal could then be compared with a digital image of the green signal in order to compare the amount of oligonucleotides binding to the chip in the two sources.

One well-known method for comparing the signal arrays in two digital images involves calculating the total intensity in each image and then calculating the ratio of these two intensities. Another method is to determine the maximum intensity in each image and to calculate the ratio of the two maximal intensities.

### DESCRIPTION OF THE INVENTION

The present invention provides a method for comparing two visual signal arrays. A signal array may be, for example, a digital image of a stained spot in a one-or two- dimensional separation pattern such as produced by electrophoresis. A signal array may also be a digital image of a region of a DNA chip that has been incubated with labeled probes that produce a visible signal. The two arrays to be compared may be physically separated from one another or superimposed upon one another.

In one embodiment of the invention, the two signal arrays to be compared are superimposed upon one another. The two arrays may be, for example, a single digital image of a region on a DNA chip that was simultaneously incubated with nucleic acid probes from two different sources, where the probes from each source are labeled with a marker producing a distinct visible signal. For example, the probes from one source may be labeled with a fluorescent label producing a red signal, and the probes from the other source labeled with a label producing a green signal. In this case, the red and green signal arrays in the digital image are superimposed upon one another, and are to be compared by the method of the invention,

When the two arrays are superimposed upon one another, each pixel xᵢ in the superimposition is described by an ordered pair of numbers (I₁(xᵢ), I₂(xᵢ)) where I₁(xᵢ) is the intensity of the signal of the pixel xᵢ in the first array, and I₂(xᵢ) is the intensity of the signal of the pixel xᵢ in the second array. A linear regression analysis is applied to the points (I₁(xᵢ)I₂(xᵢ)). Within the context of the present invention, the term “linear regression” is used to include any method in which a linear fit is found for a set of points, for example, a least squares fit of the points to a line, as is known in the art. This also includes methods involving a filtering step in which points are deleted from the set of points prior to determining the linear fit. In accordance with the invention, the two arrays are compared by means of the slope of the line produced by the linear regression analysis.

In another embodiment of the invention, two signal arrays are compared that are not superimposed upon one another. The two patterns may be, for example, digital images of spots in different one- or two- dimensional separation patterns such as produced by electrophoresis, The two arrays are first put into register with each other. Registration of the two patterns is described by means of a transformation T that maps a pixel xᵢ in the first pattern to a pixel T(xᵢ) in the second pattern. Methods for obtaining registration transformations are disclosed. for example, in Israel Patent Application No. 133562. Two arrays in register with each other under the transformations T are compared in accordance with the invention as follows. For each pixel xᵢ in the first array, an ordered pair of numbers (I(xᵢ), I(T(xᵢ)) is generated where I(xᵢ) is the intensity of the signal of a pixel xᵢ in the first array and I(T(xᵢ)) is the intensity of the pixel T(xᵢ) in the second pattern that is in register with the pixel xᵢ. A linear regression analysis is applied to the points (I(xᵢ), I(T(xᵢ)). In accordance with the invention, the two arrays are compared by means of the slope of the regression line produced by the linear regression analysis.

The invention may be used for the determination of differential gene expression. In this application, each of the signal arrays to be compared represents the level of expression of a particular gene. Typically, but not necessarily, the two arrays represent the level of the gene expression under different conditions. The invention may also be used for the determination of differential protein expression. In this application, each of the signal arrays to be compared represents the amount of a particular protein present in a sample.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a plot of the ordered pairs (I₁(x), I₂(Xᵢ)) where I₁(xᵢ) is the intensity of a signal produced by a first DNA probe species in the pixel xᵢ, I₂(xᵢ) is the intensity of a signal produced by a second DNA probe species in the pixel xᵢ, the DNA probes being bound to DNA targets on a DINA chip;

FIG. 2 shows two two-dimensional separation patterns;

FIG. 3 shows a enlargement of first and second spots from the first and second separation patterns, respectively, of FIG. 2, and

FIG. 4 shows a plot of the points (I(xᵢ), T(I(xᵢ))), where I(xᵢ) is in the intensity of a pixel xᵢ in the first spot of FIG. 3 and I(T(xᵢ)) is the intensity of a pixel T(xᵢ) in the second spot that is in register with the first spot under a transformation T.

### EXAMPLES

### Example b

Two Superimposed Spots

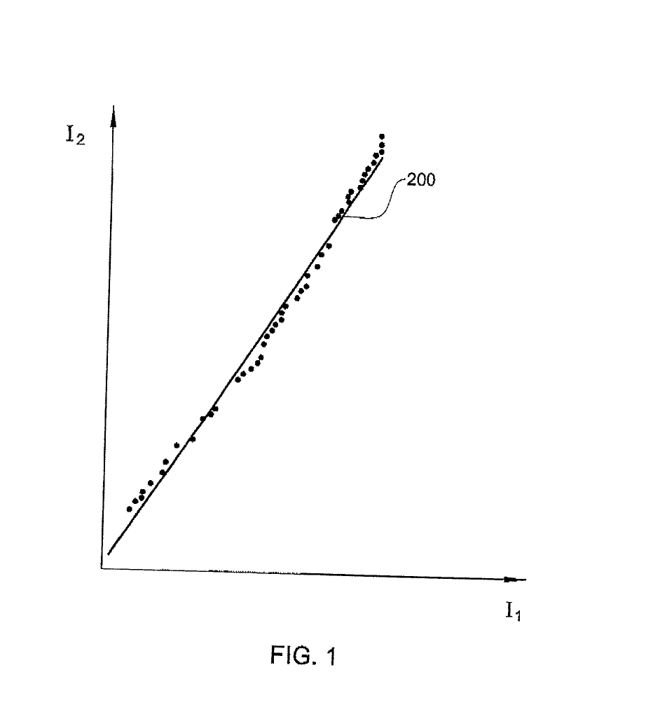

A DNA chip having DNA targets bound on it was incubated in the presence of a sample containing first and second DNA probe species, where each probe species was labeled with a label producing a distinct visible signal. Each of the first and second probe species bound to a particular target on the chip thus produces a distinct signal array in a region of the chip where the target is located. For a pixel Xᵢ, the intensity of the two signal arrays is represented by an ordered pair of numbers (I₁(xᵢ), I₂(xᵢ)) where I₁(xᵢ) is the intensity of the signal produced by the first probe species in the pixel xᵢ and I₂(xᵢ) is the intensity of the signal produced by the second probe species in the pixel xᵢ. FIG. 1 shows a plot of the ordered pairs (I₁(xᵢ), I₂(xᵢ)). A linear regression analysis was applied to the points (I₁(xᵢ), I₂(xᵢ)) that produced the best linear fit 200 to the points. The slope of the line 200 was found to be 1.48, indicating that a probes of the second species binding to a particular target on the chip were present in the sample at an abundance of about 1.48 times that of probes of the first species binding to the same target. The two spots are compared by means of the slope of the line 200.

### Example 2

Separated Arrays

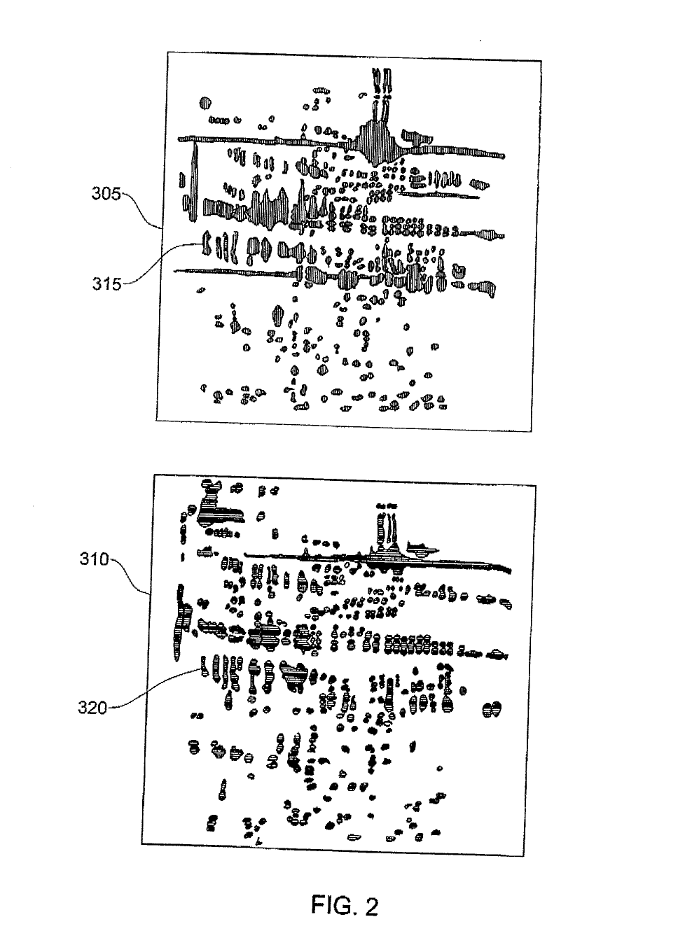

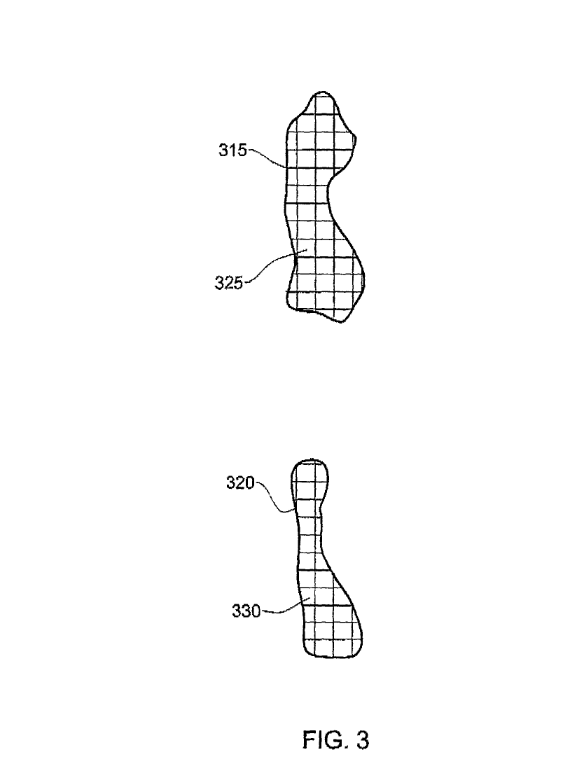

Two samples containing proteins are separated to produce a pair of two-dimensional separation patterns. FIG. 2 shows a representation of two two-dimensional separations patterns 305 and 310. A spot 315 in the first pattern 305 is to be compared with a spot 320 in the second pattern 310. FIG. 3 shows enlargements of the spots 315 and 320, divided into pixels. The pixels in each spot form a signal array. Each pixel in the spot 315, for example, the pixel 325 has an associated intensity I(xᵢ). Similarly, each pixel yᵢ in the spot 320, for example the spot 330, has an associated intensity I(yᵢ). A mapping T is found that maps each of a plurality of pixels in the spot 315 to a different pixel in the spot 320. For example, the pixel 325 may be mapped into the pixel 330.

If the two spots 315 and 320 consist of the same number of pixels, then the mapping T may be obtained by first putting the entire patterns 305 and 310 into register with each other. The patterns 305 and 310 are put in register with one another by means of a transformation T that maps each pixel xᵢ in the pattern 305, for example the pixel 330 to a pixel T(xᵢ) in the pattern 310. A transformation that puts the two patterns into register with each other may be found, for example, as disclosed in Israel Patent Application No. 133562. The restriction of the transformation T to the spot 315 maps pixels in the spot 315 to pixels in the spot 320.

Another method that may be used to put the spots 315 and 320 into register with each other whine the two spots consist of about the same number of pixels is to arrange the pixels in each spot in order of decreasing intensity The mapping T is then defined that maps the nth pixel in the arrangement of the pixels of the spot 315 with the nth spot in the arrangement of the pixels of the spot 320.

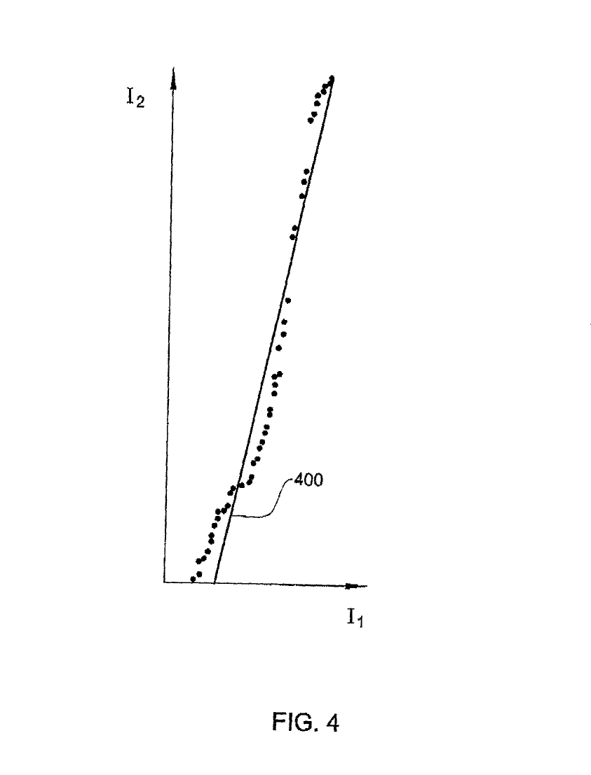

When the two spots 315 and 320 consist of about the same number of pixels, and the mapping T has been defined, pairs of numbers are (I(xᵢ), I(T(xᵢ)) formed where I(xᵢ) is in the intensity of a pixel xᵢ in the pattern 105 and I(T(xᵢ)) is the intensity of the pixel T(xᵢ) in the pattern 115 that is in register with xᵢ under the transformation T. FIG. 4 shows a plot of the points (I(xᵢ),T(I(xᵢ))). A linear regression analysis is applied to the points that produces the best linear fit 400 to the points. The slope of the linear fit 400 is found to be 4.8 indicating that the spot 320 contains about 4.8 as much protein as is present in the spot 315. The two spots are compared by means of the slope of the line 400.

If, say, the spot 315 consists of substantially more pixels than the spot 320, the following method may be used to put a plurality of the pixels of the spot 315 into register with pixels in the spot 320. The pixels in each spot are arranged in order of decreasing intensity. A predetermined fraction r₁ of the pixels in the spot 315 are then deleted from the arrangement of the pixels of that spot, to produce a provisional arrangement of the pixels of that spot. A predetermined fraction r₂ of the pixels in the spot 320 are then deleted from the arrangement of the pixels of that spot, to produce a provisional arrangement of tie pixels of that spot. r₁ and r₂ are selected so that the two provisional arrangements consist of about the same number of pixels. Preferably, the pixels deleted to form the provisional arrangements are substantially uniformly distributed in each of the initial arrangements. Thus, about every 1/r₁-th pixel is removed from the initial sequence of pixels from the spot 315 and about every 1/r₂-th pixel is removed from die initial sequence of pixels from the spot 320. A transformation T′ is then defined that maps the nth pixel in the provisional arrangement of the pixels of the spot 315 with the nth spot in the provisional arrangement of the spot 320.

Pairs of numbers are (I(x), I(T′(xᵢ))) formed where I(xᵢ) is in the intensity of a pixel xᵢ in the pattern 105 and I(T′(xᵢ)) is the intensity of the pixel T′(xᵢ) in the pattern 115 that is in register with x under tie transformation T′. FIG. 5 shows a plot of the points (I(xᵢ), T′(I(xᵢ))) A linear regression analysis is applied to the points that produces the best linear fit 500 to the points. The slope of the linear fit 500 is multiplied by r₂/r₁ to compensate for the deletion of points from the two spot arrangements.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method for comparing first and second signal arrays, the arrays being comprised of pixels, each pixel in an array having an intensity, the method comprising steps of:
(a) associating to each of a plurality of pixels xᵢ in the first array a pixel T(xᵢ) in the second array, and
(b) applying a linear regression analysis to the ordered pairs of numbers (xᵢ, T(xᵢ)) so as to produce a slope.

2. The method according to claim 1 wherein the first and second signal arrays are superposed and T(xᵢ)=xᵢ.

3. The method according to claim 2 wherein the first and second signal arrays are obtained by incubating a DNA chip in the presence of first and second probe species, the first probe species producing a signal that is distinguishable from a signal produced by the second probe species.

4. The method according to claim 2 wherein the first and second signal arrays are obtained by staining a spot in separation pattern with first and second labels, the first label producing a signal that is distinguishable from a signal produced by the second label.

5. The method according to claim 1 wherein the first and second arrays are not superimposed.

6. The method according to claim 5 wherein the first and second signal arrays are spots in a first and second separation pattern, respectively.

7. The method according to claim 6 wherein the first and second separation patterns are in register, and for each pixel xᵢ in the first spot, T(xᵢ) is the spot in the second separation pattern in register with xᵢ.

8. The method according to any one of the previous claims for use in determining differential gene expression or differential protein expression.

9. A method for determining differential gene expression of a gene comprising steps of:
(a) obtaining digitized images of first and second signal arrays representing first and second expression levels of the gene, respectively, each pixel in all image having an intensity;
(b) associating to each of a plurality of pixels xᵢ in the first image a pixel T(xᵢ) in the second image, and
(c) applying a linear regression analysis to the ordered pairs of numbers (xᵢ, T(xᵢ)) so as to produce a slope.

10. The method according to claim 9 wherein the first and second signal arrays are superimposed kind T(xᵢ)=xᵢ.

11. The method according to claim 10 wherein the first and second signal arrays are obtained by incubating a DNA chip in the presence of first and second probe species, the first probe species producing a signal that is distinguishable from a signal produced by the second probe species.

12. The method according to claim 10 wherein the first and second signal arrays are obtained by staining a spot in separation pattern with first and second labels, the first label producing a signal that is distinguishable from a signal produced by the second label.

13. A method for determining differential protein expression comprising steps of:
(a) obtaining digitized images of first and second signal arrays representing first and second expression levels of the protein, respectively, each pixel in an image having an intensity;
(b) associating to each of a plurality of pixels xᵢ in the first image a pixel T(xᵢ) in the second image, and
(c) applying a linear regression analysis to the ordered pairs of numbers (xᵢ, T(xᵢ)) so as to produce a slope.

14. The method according to claim 13 wherein the first and second arrays are not superimposed.

15. The method according to claim 14 wherein the first and second signal arrays are spots in a first and second separation pattern, respectively.

16. The method according to claim 15 wherein the first and second separation patterns are in register, and for each pixel xᵢ in the first spot, T(xᵢ) is the spot in the second separation pattern in register with xᵢ.

17. A program storage device readable by machine, tangibly embodying a program of institutions executable by the machine to perform method steps for comparing digitized images of first and second signal arrays, the images being comprised of pixels, each pixel in an image having an intensity, the method comprising steps of:
(a) associating to each of a plurality of pixels xᵢ in the first image a pixel T(xᵢ) in the second image, and
(b) applying a linear regression analysis to the ordered pairs of numbers (xᵢ, T(xᵢ)) so as to produce a slope.

18. A computer program product comprising a computer useable medium having computer readable program code embodied therein for comparing digitized images of first and second signal arrays, the images being comprised of pixels, each pixel in an image having an intensity, the computer program product comprising:
computer readable program code for causing the computer to associate to each of a plurality of pixels xᵢ in the first image a pixel T(xᵢ) in the second image, and
computer readable program code for causing the computer to apply a linear regression analysis to the ordered pairs of numbers (xᵢ, T(xᵢ)) so as to produce a slope.

19. A program storage device readable by machine, tangibly embodying a program of instructions executable by the machine to perform method steps for determining differential gene expression of a gene comprising steps of;
(a) obtaining digitized images of first and second signal arrays representing first and second expression levels of the gene, respectively, each pixel in an image having an intensity;
(b) associating to each of a plurality of pixels xᵢ in the first image a pixel T(xᵢ) in the second image, and
(c) applying a linear regression analysis to the ordered pairs of numbers (xᵢ, T(xᵢ)) so as to produce a slope.

20. A computer program product comprising a computer useable medium having computer readable program code embodied therein for determining differential gene expression of a gene the computer program product comprising:
computer readable program code for causing the computer to obtain digitized images of first and second signal arrays representing first and second expression levels of the gene, respectively, each pixel in an image having an intensity;
computer readable program code for causing the computer to associate to each of a plurality of pixels xᵢ in the first image a pixel T(xᵢ) in the second image, and
computer readable program code for causing the computer to apply a linear regression analysis to the ordered pairs of numbers (xᵢ, T(xᵢ)) so as to produce a slope.

21. A program storage device readable by machine, tangibly embodying a program of instructions executable by the machine to perform method steps for determining differential protein expression comprising steps of:
(a) obtaining digitized images of first and second signal arrays representing first and second expression levels of the protein, respectively, each pixel in an image having an intensity:
(b) associating to each of a plurality of pixels xᵢ in the first image a pixel T(xᵢ) in the second image, and
(c) applying a linear regression analysis to the ordered pairs of numbers (xᵢ, T(xᵢ)) so as to produce a slope.

22. A computer program product comprising a computer useable medium having computer readable program code embodied therein for determining differential protein expression the computer program product comprising:
computer readable program code for causing the computer to obtain digitized images of first and second signal arrays representing first and second expression levels of the protein, respectively, each pixel in an image having an intensity;
computer readable program code for causing the computer to associate to each of a plurality of pixels xᵢ in the first image a pixel T(xᵢ) in the second image, and
computer readable program code for causing the computer to apply a linear regression analysis to the ordered pairs of numbers (xᵢ, T(xᵢ)) so as to produce a slope.
